(19) United States
(12) Patent Application Publication
(10) Pub. No.: US 2014/0239716 A1
(43) Pub. Date: Aug. 28, 2014

(54) AC POWER SUPPLY APPARATUS

(71) Applicant: TAKASAGO, LTD., Kawasaki (JP)

(72) Inventors: Yasuhiro ISHIKAWA, Kanagawa (JP); Kazuaki HONDA, Kanagawa (JP)

(73) Assignee: TAKASAGO, LTD., Kawasaki (JP)

(21) Appl. No.: 14/065,654

(22) Filed: Oct. 29, 2013

(30) Foreign Application Priority Data
Feb. 22, 2013 (JP) 2013-033784

(51) Int. Cl. G05F 1/12

(52) U.S. Cl. CPC G05F 1/12
USPC 307/18; 307/52

(57) ABSTRACT

Provided is an AC power supply apparatus including a first AC power supply generation unit that generates a first AC voltage for a first terminal corresponding to a u-phase; a second AC power supply generation unit that generates a second AC voltage for a second terminal corresponding to a v-phase; a third AC power supply generation unit that generates a third AC voltage for a third terminal corresponding to a w-phase; and a control unit that controls a phase and an amplitude of each of the AC voltages output from the first to third AC power supply generation units, in such a manner that the amplitude and the phase of each of the first to third AC voltages output to the first to third terminals, respectively, match an amplitude set value and a phase set value preliminarily set for each of the AC voltages.

### INCORPORATION BY REFERENCE

This application is based upon and claims the benefit of priority from Japanese patent application No. 2013-033784, filed on Feb. 22, 2013, the disclosure of which is incorporated herein in its entirety by reference.

### BACKGROUND OF THE INVENTION

1. Field of the Invention

The present invention relates to an AC (Alternate Current) power supply apparatus that supplies power to another device by using an AC voltage.

2. Description of Related Art

In general, devices such as home appliances operate based on power supplied from a system line using an AC voltage. In recent years, there are many proposals for an AC power supply apparatus that generates AC power for these electric appliances in order to use the electric appliances in case of emergency, such as a power interruption or disturbance, or to use the electric appliances outdoors. Such an AC power supply apparatus generally supplies power to electric appliances via a single-phase three-wire supply source system or a three-phase three-wire supply source system. For example, in the case of supplying power via a single-phase three-wire supply source system, if an imbalance occurs in magnitude between loads connected to respective phases, an imbalance in voltage between the phases occurs, which results in a problem that the amplitude of an AC voltage to be applied to electric appliances deviates from a desired value.

In this regard, Japanese Unexamined Patent Application Publication Nos. 2005-137070 and 2007-166869 disclose a technique for eliminating an amplitude shift due to an imbalance in magnitude between loads in an AC power supply apparatus.

According to Japanese Unexamined Patent Application Publication No. 2005-137070, in a single-phase three-wire supply source system utility-interconnection inverter, half-bridge inverters interconnected with each other are provided at an a-phase side and a b-phase side, and the magnitude of an output current command with respect to each of the half-bridge inverters is controlled in proportion to the magnitude of each of the loads of the a-phase and the b-phase. Specifically, when the magnitude of the load of one of the a-phase and the b-phase is larger, the output for each phase is increased in proportion to the magnitude, and when the magnitude of the load of one of the a-phase and the b-phase is smaller, the output for each phase is decreased. Meanwhile, a function for limiting the current outputs thus determined is provided so that the system power is limited by means of controlling the power of both the current outputs. Thus, in Japanese Unexamined Patent Application Publication No. 2005-137070, the degree of imbalance is reduced even when the loads connected to the single-phase three-wire supply source system are in an unbalanced state.

Japanese Unexamined Patent Application Publication No. 2007-166869 discloses a power supply apparatus that is interconnected with a single-phase three-wire distribution system. The power supply apparatus includes a power supply body that outputs DC power of a solar cell, a wind turbine generator, or the like; an inverter circuit that converts the DC power from the power supply body into AC power, and outputs the AC power to the distribution system; and a control device that controls the inverter circuit to balance voltages between a neutral line N of the distribution system and each voltage line, or to minimize a difference between the voltages, thereby causing the inverter circuit to output active power or reactive power. Thus, in Japanese Unexamined Patent Application Publication No. 2007-166869, a voltage imbalance due to an imbalance between loads, or an imbalance between voltages to be supplied is compensated, and a voltage rise in lead-in wires and interior wiring is suppressed so as to increase, as much as possible, the effective output of the inverter until the limitation of the power supply apparatus occurs, thereby preventing suppression of the output of the power supply apparatus.

### SUMMARY

In Japanese Unexamined Patent Application Publication Nos. 2005-137070 and 2007-166869, correction is performed by focusing only on the amplitude of the AC voltage. Accordingly, a prescribed amplitude can be obtained when a first phase and a second phase are separately used (for example, power of 100 V for each phase). However, in Japanese Unexamined Patent Application Publication Nos. 2005-137070 and 2007-166869, a phase shift between two phases due to an imbalance between loads cannot be eliminated. This causes a problem that when the first phase and the second phase are combined to obtain a double voltage (for example, power of 200 V), for example, a desired amplitude cannot be obtained due to a phase shift occurring between two phases, even if the phases are combined.

In an exemplary aspect of the invention, an AC power supply apparatus according to an exemplary aspect of the present invention includes: a first AC power supply generation unit that generates a first AC voltage for a first terminal corresponding to a u-phase; a second AC power supply generation unit that generates a second AC voltage for a second terminal corresponding to a v-phase; a third AC power supply generation unit that generates a third AC voltage for a third terminal corresponding to a w-phase; and a control unit that controls a phase and an amplitude of each of the AC voltages output from the first to third AC power supply generation units, in such a manner that the amplitude and the phase of each of the first to third AC voltages output to the first to third terminals, respectively, match an amplitude set value and a phase set value, the amplitude set value and the phase set value being preliminarily set.

### BRIEF DESCRIPTION OF THE DRAWINGS

The above and other aspects, features, and advantages of the present invention will become more apparent from the following description of certain exemplary embodiments when taken in conjunction with the accompanying drawings, in which:

FIG. 1 is a block diagram of an AC power supply apparatus according to a first exemplary embodiment;

FIG. 2 is a detailed block diagram of the AC power supply apparatus according to the first exemplary embodiment;

FIG. 3 is a vector diagram showing an amplitude and a phase in each phase when loads are in a balanced state;

FIG. 4 is a vector diagram showing an amplitude and a phase in each phase when loads are in an unbalanced state;

FIG. 5 is a vector diagram showing an outline of correction processing in the AC power supply apparatus according to the first exemplary embodiment;

FIG. 6 is a block diagram of an AC power supply apparatus according to a second exemplary embodiment;

FIG. 7 is a detailed block diagram of the AC power supply apparatus according to the second exemplary embodiment; and

FIG. 8 is a vector diagram showing an amplitude and a phase in each phase when loads are in a balanced state in the AC power supply apparatus according to the second exemplary embodiment.

### EXEMPLARY EMBODIMENTS

### First Exemplary Embodiment

Exemplary embodiments of the present invention will be described below with reference to the drawings.

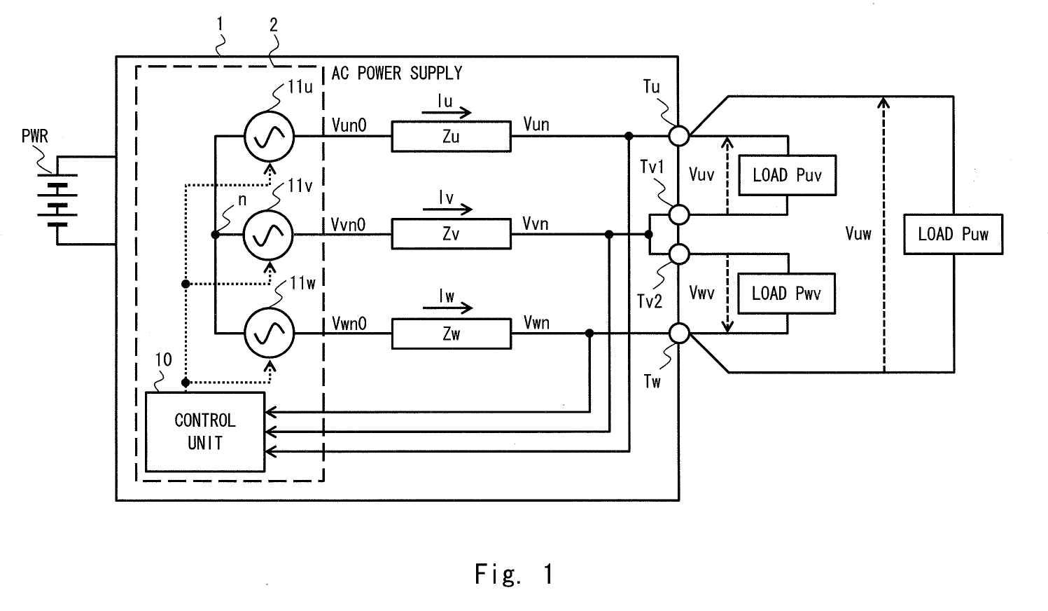

FIG. 1 is a block diagram of an AC power supply apparatus 1 according to a first exemplary embodiment. FIG. 1 shows a first load (for example, a load Puv), a second load (for example, a load Pwv), and a third load (for example, a load Puw), each of which is supplied with an AC voltage generated by the AC power supply apparatus 1, and a DC power supply PWR that supplies operating power for the AC power supply apparatus 1. As shown in FIG. 1, the AC power supply apparatus 1 according to the first exemplary embodiment includes an AC power supply 2. The AC power supply 2 includes a control unit 10, a first AC power supply generation unit (for example, an AC power supply generation unit 11u), a second AC power supply generation unit (for example, an AC power supply generation unit 11v), a third AC power supply generation unit (for example, an AC power supply generation unit 11w), and terminals Tu, Tv1, Tv2, and Tw.

As shown in FIG. 1, the load Puv is connected between the terminal Tu and the terminal Tv1. A potential Vun output through an impedance Zu is supplied to the terminal Tu of the load Puv, and a potential Vvn output through an impedance Zv is supplied to the other terminal Tv1 of the load Puv. The load Pwv is connected between the terminal Tv2 and the terminal Tw. A potential Vwn output through an impedance Zw is supplied to the terminal Tw of the load Pwv, and the potential Vvn passing through the impedance Zv is supplied to the other terminal Tv2 of the load Pwv. The load Puw is connected between the terminal Tu and the terminal Tw. The potential Vun is supplied to the terminal Tu of the load Puw, and the potential Vwn is supplied to the terminal Tw of the load Puw.

The terminal Tu is a first terminal that outputs a first AC voltage corresponding to a u-phase in the AC voltage output from the AC power supply apparatus 1. The AC power supply generation unit 11u generates the first AC voltage and outputs the first AC voltage to the terminal Tu. The AC power supply generation unit 11u and the terminal Tu are connected with a line. This line has the impedance Zu. When a current Iu output from the AC power supply generation unit 11u flows through this line, a voltage difference and a phase difference occur between a first AC voltage Vun0 output from the AC power supply generation unit 11u, and the first AC voltage Vun supplied to the loads Puv and Puw. Note that the impedance Zu of the line connecting the AC power supply generation unit 11u with the terminal Tu is generated by a first impedance element. The first impedance element is, for example, a filter which is provided on this line.

Each of the terminals Tv1 and Tv2 is a second terminal that divides and outputs a second AC voltage corresponding to a v-phase in the AC voltage output from the AC power supply apparatus 1. The AC power supply generation unit 11v generates the second AC voltage and outputs the second AC voltage to the terminals Tv1 and Tv2. The AC power supply generation unit 11v and the terminals Tv1 and Tv2 are connected with a line. This line has the impedance Zv. When a current Iv output from the AC power supply generation unit 11v flows through this line, a voltage difference and a phase difference occur between a second AC voltage Vvn0 output from the AC power supply generation unit 11v and the second AC voltage Vvn supplied to the loads Puv and Pwv. Note that the impedance Zv of the line connecting the AC power supply generation unit 11v and the terminals Tv1 and Tv2 is generated by a second impedance element. The second impedance element is, for example, a filter which is provided on this line.

The terminal Tw is a third terminal that outputs a third AC voltage corresponding to a w-phase in the AC voltage output from the AC power supply apparatus 1. The AC power supply generation unit 11w generates the third AC voltage and outputs the third AC voltage to the terminal Tw. The AC power supply generation unit 11w and the terminal Tw are connected with a line. This line has the impedance Zw. When a current Iw output from the AC power supply generation unit 11w flows through this line, a voltage difference and a phase difference occur between a third AC voltage Vwn0 output from the AC power supply generation unit 11w and the third AC voltage Vwn supplied to the loads Pwv and Puw. Note that the impedance Zw of the line connecting the AC power supply generation unit 11w and the terminal Tw is generated by a third impedance element. The third impedance element is, for example, a filter which is provided on this line.

The control unit 10 controls the phase and the amplitude of each of the AC voltages, which are output from the AC power supply generation units 11u, 11v, and 11w, in such a manner that the amplitude and the phase of each of the first AC voltage Vun, which is output to the terminal Tu, the second AC voltage Vvn, which is output to the terminals Tv1 and Tv2, and the third AC voltage Vwn, which is output to the terminal Tw, match an amplitude set value and a phase set value which are preliminarily set for each of the AC voltages. More specifically, the control unit 10 generates control signals for controlling the AC power supply generation units 11u, 11v, and 11w based on vector values representing an amplitude component and a phase component of each AC voltage. Details of the control unit 10 will be described later.

Each of the AC power supply generation units 11u, 11v, and 11w generates an AC voltage. For example, the AC power supply generation units 11u, 11v, and 11w receive PWM (Pulse Width Modulation) signals, which are output from the control 10, as the control signals, and control the amplitude, phase, frequency, and the like of the output AC voltage according to variables such as the pulse width, phase, and frequency of the PWM signals. In this case, the PWM signals are illustrated as an example of the control signals, but other signals including sine waves may also be used as the control signals.

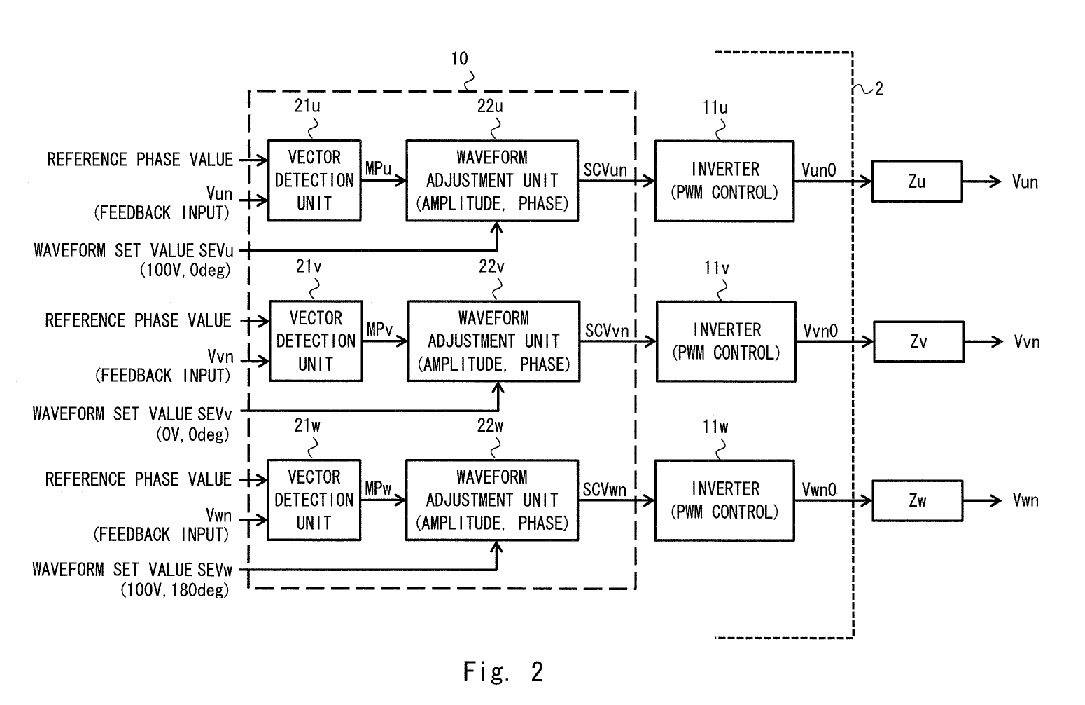

Next, the control unit 10 and the AC power supply generation units 11u, 11v, and 11w will be described in more detail. In this regard, FIG. 2 shows a detailed block diagram of the AC power supply apparatus according to the first exemplary embodiment.

As shown in FIG. 2, the AC power supply apparatus 1 includes inverters 11u, 11v, and 11w as the AC power supply generation units 11u, 11v, and 11w shown in FIG. 1. The inverters 11u, 11v, and 11w operate upon receiving the control signals from the control unit 10. The control unit 10 has a configuration in which a processor provided for each phase generates control signals for each phase. In the AC power supply apparatus 1 according to the first exemplary embodiment, a vector detection unit 21u and a waveform adjustment unit 22u generate a control signal SCVun corresponding to the u-phase; a vector detection unit 21v and a waveform adjustment unit 22v generate a control signal SCVvn corresponding to the v-phase; and a vector detection unit 21w and a waveform adjustment unit 22w generate a control signal SCVwn corresponding to the w-phase.

In this case, the vector detection unit 21u divides the first AC voltage Vun output from the terminal Tu, and uses one of the divided voltages as a feedback input to the vector detection unit 21u, thereby detecting a measurement vector value MPu representing the amplitude and phase of the AC voltage Vun. The vector detection unit 21v divides the second AC voltage Vvn output from the terminals Tv1 and Tv2, and uses one of the divided voltages as a feedback input to the vector detection unit 21v, thereby calculating a measurement vector value MPv representing the amplitude and phase of the AC voltage Vvn. The vector detection unit 21w divides the third AC voltage Vwn output from the terminal Tw, and uses one of the divided voltages as a feedback input to the vector detection unit 21w, thereby calculating a measurement vector value MPw representing the amplitude and phase of the AC voltage Vwn. In this case, each of the vector detection units 21u, 21v, and 21w receives a reference phase value which is a reference value for the phase of the AC voltage. Each of the vector detection units 21u, 21v, and 21w detects a phase difference component between the reference phase value and the corresponding AC voltage to be fed back and received, and includes the amplitude of the AC voltage, which is fed back and received, in the measurement vector value. In the first exemplary embodiment, the AC power supply apparatus 1 operates with an “n” point as a reference point. The reference phase value is a value representing the phase at the “n” point.

The waveform adjustment unit 22u calculates a difference value between a waveform set value SEVu, which represents an amplitude set value and a phase set value, and the measurement vector value MPu, and updates the control signal SCVun so as to decrease the difference value. The waveform adjustment unit 22v calculates a difference value between a waveform set value SEVv, which represents an amplitude set value and a phase set value, and the measurement vector value MPv, and updates the control signal SCVvn so as to decrease the difference value. The waveform adjustment unit 22w calculates a difference value between a waveform set value SEVw, which represents an amplitude set value and a phase set value, and the measurement vector value MPw, and updates the control signal SCVwn so as to decrease the difference value.

In the first exemplary embodiment, the AC power supply apparatus 1 is caused to operate as an AC power supply of a single-phase three-wire supply source system. Accordingly, a vector value including a 100 V amplitude component and a 0-degree phase component is set as the waveform set value SEVu; a vector value including a 0 V amplitude component and a 0-degree phase component is set as the waveform set value SEVv; and a vector value including a 100 V amplitude component and a 180-degree phase component is set as the waveform set value SEVw. To obtain the waveform set values, there are methods including a method of inputting, as a control value, an output from a memory, a computer, or the like, which is installed outside the control unit 10, to the waveform adjustment unit; a method of installing a memory storing a control value in the control unit 10 and inputting the control value to the waveform adjustment unit; and a method of providing a memory function in the waveform adjustment unit, for example. The waveform set values are preferably stored in a non-volatile memory such as a dual in-line package switch or a flash memory.

The waveform adjustment units 22u, 22v, and 22w perform processing, such as an integral control, by using the difference between the measurement vector value and the waveform set value, and output the control signals SCVun, SCVvn, and SCVwn (for example, PWM signals), respectively. Thus, in the AC power supply apparatus 1 according to the first exemplary embodiment, the amplitude and the phase of the AC voltages output from the terminals Tu, Tv1, Tv2, and Tw match the values specified by the waveform set values.

Next, the operation of the AC power supply apparatus 1 according to the first exemplary embodiment will be described. Since the AC power supply apparatus 1 is caused to operate as an AC power supply of a single-phase three-wire supply source system in the first exemplary embodiment, a state in which the AC voltage generated across the both ends of the load Puv and the AC voltage generated across the both ends of the load Pwv have the same amplitude and reversed phases is an ideal state. Furthermore, in the AC power supply of the single-phase three-wire supply source system, a state in which the second AC voltage Vvn has an amplitude of 0 V is an ideal state.

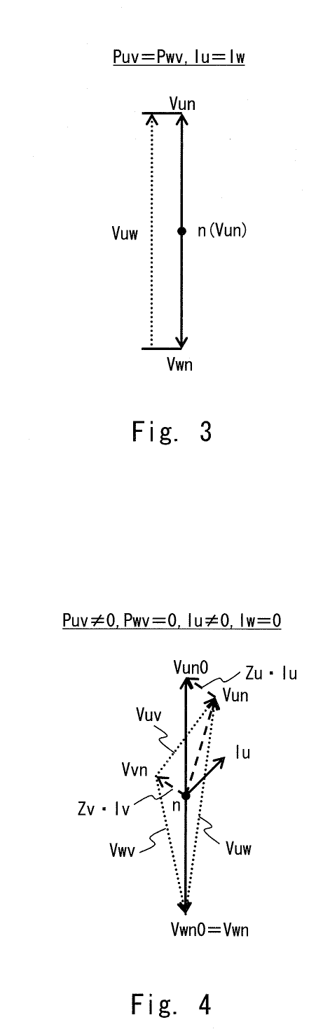

In this regard, FIG. 3 is a vector diagram showing an amplitude and a phase in each phase when the loads Puv and Pwv are in a balanced state. Note that in a plurality of vector diagrams explained below, assume that the length of each vector represents an amplitude of an AC voltage, and an inclination with respect to a central line (a line in the vertical direction passing through the reference point “n”) in the vertical direction of each vector diagram represents a phase of an AC voltage.

As shown in FIG. 3, when all loads connected to the AC power supply generation units 11u, 11v, and 11w (for example, in the case of the AC power supply generation unit 11u, the impedance Zu is also included as a load) are in a balanced state, the same current flows through the loads Puv and Pwv. Accordingly, the vector of the first AC voltage Vun and the vector of the third AC voltage Vwn have the same magnitude and are shifted from each other by 180 degrees. Specifically, when the loads are in a balanced state, AC voltages having the same amplitude are applied to the loads Puv and Pwv, and an AC voltage having an amplitude twice as large as the amplitude to be applied to the loads Puv and Pwv is applied to the load Puw.

Next, FIG. 4 is a vector diagram showing an amplitude and a phase in each phase when the loads are in an unbalanced state. In the vector diagram shown in FIG. 4, vector correction is not performed by the control unit 10 of the AC power supply apparatus 1 according to the first exemplary embodiment. The example shown in FIG. 4 illustrates the state in which the load Pwv is 0 and the current Iw is 0.

As shown in FIG. 4, when the loads are in an unbalanced state, the current Iw does not flow. Accordingly, an AC voltage having the same amplitude and phase as those of the third AC voltage Vwn0 output from the AC power supply generation unit 11w is output as the third AC voltage Vwn. In other words, no shift occurs in the third AC voltage Vwn.

Meanwhile, when the loads are in an unbalanced state, a current flows through the load Puv, so that the current Iu flows through the impedance Zu and the current Iv having the same magnitude as that of the current Iu flows through the impedance Zv. As a result, a shift having a magnitude and an inclination of Zulu occurs between the first AC voltage Vun0 output from the AC power supply generation unit 11u and the first AC voltage Vun output from the terminal Tu. The shift between the AC voltages causes a problem that the amplitude Vuw of the AC voltage applied between the terminal Tu and the terminal Tw becomes smaller than that of the example shown in FIG. 3. Further, when the loads are in an unbalanced state as shown in FIG. 4, the current Iu flows through the load Puv as the current Iv. Accordingly, in the ideal state, the second AC voltage Vvn that matches the reference point “n” is shifted by the amount of Zv·Iv(=Iu).

Therefore, in the AC power supply apparatus 1 according to the first exemplary embodiment, the amplitude and phase of each of the first AC voltage Vun0 and the second AC voltage Vvn0, which are output from the inverters 11u and 11v, respectively, are adjusted such that the vector values (for example, an amplitude and a phase) of the first AC voltage Vun and the second AC voltage Vvn become the values in the state shown in FIG. 3. More specifically, in the AC power supply apparatus 1 according to the first exemplary embodiment, the third AC voltage Vwn is obtained from the first AC voltage Vun at a location closest to the AC voltage to be applied to the loads. Further, the control unit 10 performs an integral control such that the amplitude and phase of the measured AC voltage match the waveform set value representing the ideal state, thereby controlling the amplitude and phase of the AC voltage to be applied to the loads.

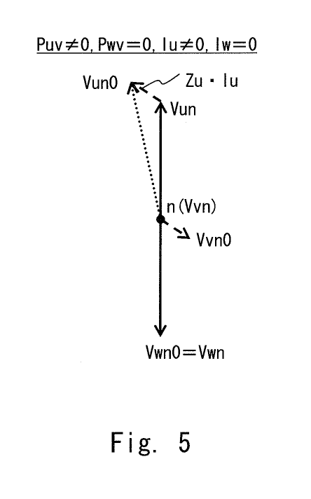

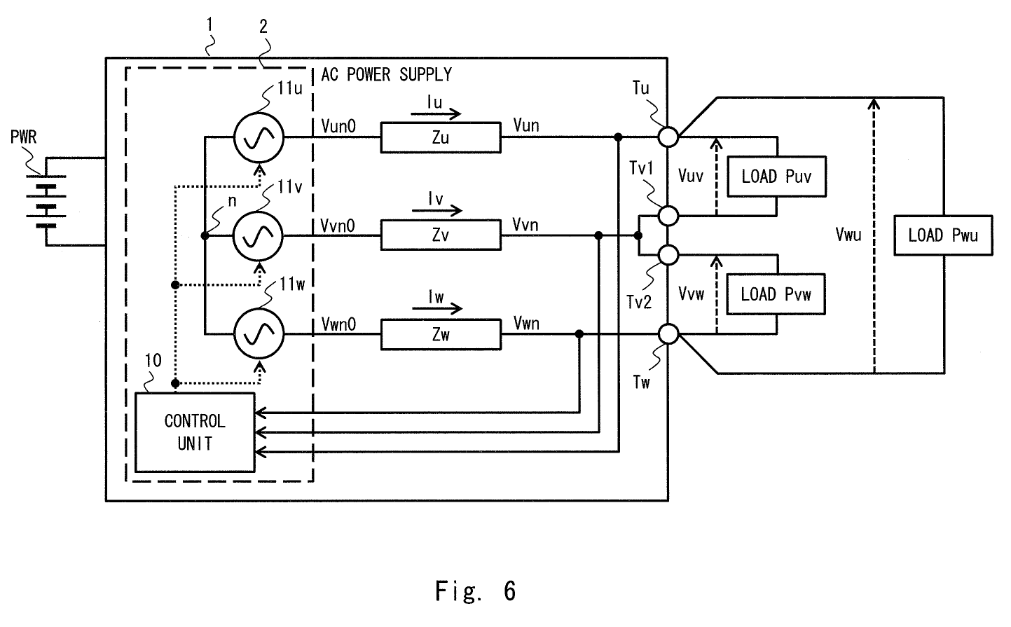

In this regard, FIG. 5 is a vector diagram showing an outline of correction processing in the AC power supply apparatus 1 according to the first exemplary embodiment. As shown in FIG. 5, the control unit 10 controls the AC power supply generation units 11u, 11v, and 11w in such a manner that the first AC voltage Vun0 and the second AC voltage Vvn0, which are output from the AC power supply generation units 11u and 11v, respectively, match the vector values having a magnitude specified by the waveform set value, when the first AC voltage Vun0 and the second AC voltage Vvn0 are shifted due to the impedances Zu and Zv.

As described above, in the AC power supply apparatus 1 according to the first exemplary embodiment, even when the loads are in an unbalanced state, the amplitude and phase of the AC voltage to be applied to the loads can be maintained at the values specified by the waveform set value which is preliminarily set. Consequently, the AC power supply apparatus 1 according to the first exemplary embodiment can maintain the magnitude of each amplitude (for example, amplitudes Vuv and Vwv) obtained from a single-phase AC voltage, and the magnitude of each amplitude (for example, amplitude Vuw) obtained from a two-phase AC voltage, regardless of the fluctuation of the unbalanced state of the loads.

Moreover, in the AC power supply apparatus 1 according to the first exemplary embodiment, the amplitude and phase of the AC voltage output from the AC power supply apparatus 1 are monitored by feedback, thereby continuously adjusting the amplitude and phase of the AC voltage. Accordingly, even when the magnitude of each load continuously changes, the AC power supply apparatus 1 according to the first exemplary embodiment can maintain the magnitude and amplitude of the AC voltage while following the change. For example, electric appliances rarely operate at the same load constantly, and in general, the magnitude of each load constantly varies. Therefore, the following capability with respect to a load variation is extremely important for stable operation of electric appliances.

### Second Exemplary Embodiment

While the first exemplary embodiment illustrates the case where the AC power supply apparatus 1 is used as a power supply of a single-phase three-wire supply source system, a second exemplary embodiment illustrates the case where the AC power supply apparatus 1 is used as a power supply of a three-phase three-wire supply source system. In this regard, FIG. 6 shows a block diagram of the AC power supply apparatus 1 according to the second exemplary embodiment.

As shown in FIG. 6, voltages applied to the loads connected to the outside of the AC power supply apparatus 1 according to the second exemplary embodiment are different from those of the first exemplary embodiment. More specifically, in the second exemplary embodiment, the load Puv is connected between the terminal Tu and the terminal Tv1; a load Pvw is connected between the terminal Tv2 and the terminal Tw; and a load Pwu is connected between the terminal Tu and the terminal Tw. The potential Vun output through the impedance Zu is applied to the terminal Tu of the load Puv, and the potential Vvn output through the impedance Zv is applied to the terminal Tv1 of the load Puv. Hereinafter, the voltage applied to the both ends of the load Puv is referred to as the voltage Vuv. The potential Vvn is applied to the terminal Tv2 of the load Pvw, and the potential Vwn output through the impedance Zw is applied to the terminal Tw of the load Pvw. Hereinafter, the voltage applied to the both ends of the load Pvw is referred to as a voltage Vvw. The potential Vun is applied to the terminal Tu of the load Pwu, and the potential Vwn is applied to the terminal Tw of the load Pwu. Hereinafter, the voltage applied to the both ends of the load Pwu is referred to as a voltage Vwu.

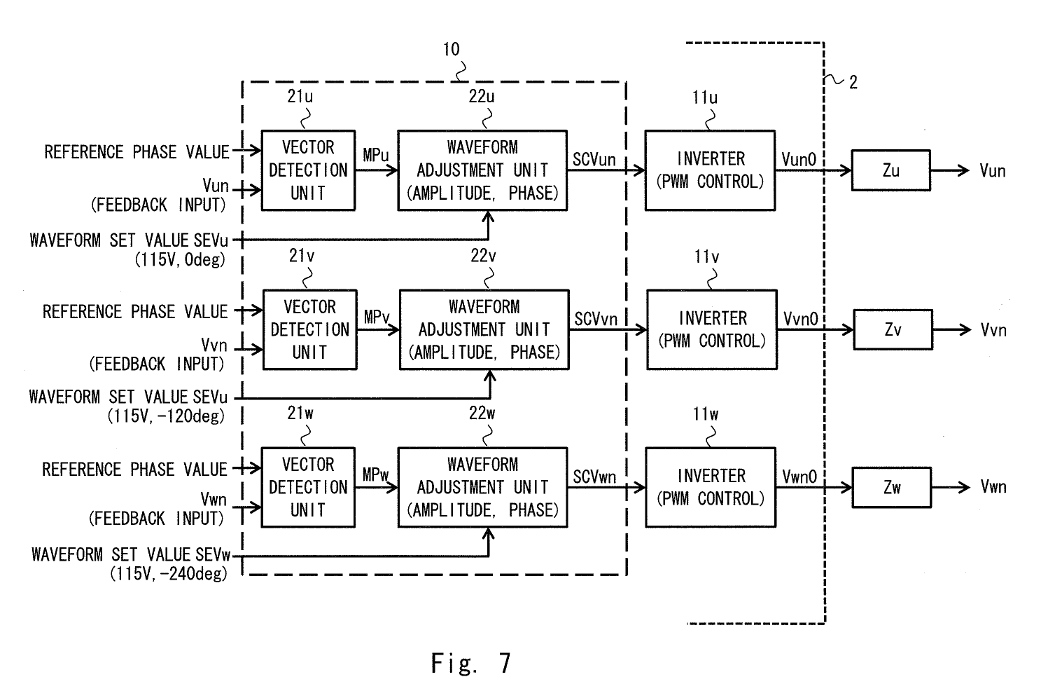

Next, FIG. 7 shows a detailed block diagram of the AC power supply apparatus 1 according to the second exemplary embodiment. As shown in FIG. 7, the block configuration of the AC power supply apparatus 1 according to the second exemplary embodiment is the same as that of the AC power supply apparatus 1 according to the first exemplary embodiment, but the waveform set values of the AC power supply apparatus 1 according to the second exemplary embodiment are different from those of the AC power supply apparatus 1 according to the first exemplary embodiment. Specifically, in the second exemplary embodiment, an amplitude of 115 V and a phase of 0 degrees are set as the waveform set value SEVu of the first AC voltage Vun corresponding to the u-phase. An amplitude of 115 V and a phase of −120 degrees are set as the waveform set value SEVv of the second AC voltage Vvn corresponding to the v-phase. An amplitude of 115 V and a phase of −240 degrees are set as the waveform set value SEVw of the third AC voltage Vwn corresponding to the w-phase. The waveform set values are preferably stored in a non-volatile memory as in the first exemplary embodiment.

Also in the second exemplary embodiment, the reference phase value is used for the vector detection units 21u, 21v, and 21w. Also in the second exemplary embodiment, the AC power supply apparatus 1 operates with the “n” point as the reference point.

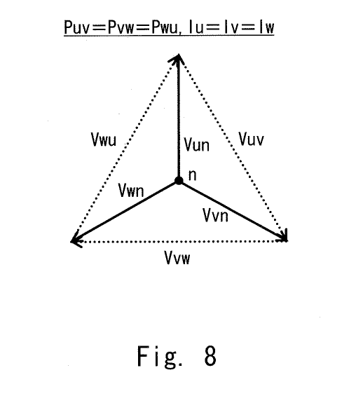

Next, the operation of the AC power supply apparatus 1 according to the second exemplary embodiment will be described. In this regard, FIG. 8 is a vector diagram showing an amplitude and a phase in each phase when the loads in the AC power supply apparatus according to the second exemplary embodiment are in a balanced state.

As shown in FIG. 8, in the AC power supply apparatus 1 according to the second exemplary embodiment, when all loads connected to the AC power supply generation units 11u, 11v, and 11w (for example, in the case of the AC power supply generation unit 11u, the impedance Zu is also included as a load) are in a balanced state, the first AC voltage Vun, the second AC voltage Vvn, and the third AC voltage Vwn have the same amplitude. When the loads are in a balanced state, the phase difference between the first AC voltage Vun and the second AC voltage Vvn, the phase difference between the second AC voltage Vvn and the third AC voltage Vwn, and the phase difference between the third AC voltage Vwn and the first AC voltage Vun are each 120 degrees.

At this time, when the loads are in an unbalanced state, correction processing similar to that performed in the AC power supply apparatus 1 according to the first exemplary embodiment is performed also in the AC power supply apparatus 1 according to the second exemplary embodiment. Specifically, also in the second exemplary embodiment, the AC power supply apparatus 1 controls the phase and amplitude of each of the first AC voltage Vun0, the second AC voltage Vvn0, and the third AC voltage Vwn0, which are output from the respective AC power supply generation units 11 corresponding to the respective phases, in such a manner that the first AC voltage Vun, the second AC voltage Vvn, and the third AC voltage Vwn obtained after a phase shift and an amplitude shift occur due to the impedances Zu, Zv, and Zw match the values set by the waveform set values.

As described above, the second exemplary embodiment illustrates the case where the AC power supply apparatus 1 is used as an AC power supply of a three-phase three-wire supply source system. In this manner, the correction processing performed by the AC power supply apparatus 1 described in the first exemplary embodiment can be applied not only to a single-phase three-wire supply source system but also to a three-phase three-wire supply source system.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. An AC power supply apparatus comprising:
a first AC power supply generation unit that generates a first AC voltage for a first terminal corresponding to a u-phase;
a second AC power supply generation unit that generates a second AC voltage for a second terminal corresponding to a v-phase;
a third AC power supply generation unit that generates a third AC voltage for a third terminal corresponding to a w-phase; and
a control unit that controls a phase and an amplitude of each of the AC voltages output from the first to third AC power supply generation units, in such a manner that the amplitude and the phase of each of the first to third AC voltages output to the first to third terminals, respectively, match an amplitude set value and a phase set value, the amplitude set value and the phase set value being preliminarily set for each of the AC voltages.

2. The AC power supply apparatus according to claim 1, wherein the control unit generates a control signal for controlling the first to third AC power supply generation units based on a vector value representing an amplitude component and a phase component of each of the AC voltages.

3. The AC power supply apparatus according to claim 2, wherein
the control unit comprises:
a vector detection unit that calculates a measurement vector value representing an amplitude and a phase of each of the first to third AC voltages output to the first to third terminals, respectively; and
a waveform adjustment unit that calculates a difference value between the measurement vector value and a waveform set value representing the amplitude set value and the phase set value, and updates the control signal for controlling the first to third AC power supply generation units, so as to decrease the difference value.

4. The AC power supply apparatus according to claim 3, wherein
the first to third AC power supply generation units generate the first to third AC voltages, respectively, based on the control signal output from the control unit, and
the waveform adjustment unit outputs the control signal and adjusts a pulse width and a phase of the control signal according to the difference value.

5. The AC power supply apparatus according to claim 4, wherein the vector detection unit uses, as a phase component of the measurement vector value, a difference value between a preliminarily set reference phase value and the phase of each of the first to third AC voltages.

6. The AC power supply apparatus according to claim 3, wherein the vector detection unit uses, as a phase component of the measurement vector value, a difference value between a preliminarily set reference phase value and the phase of each of the first to third AC voltages.

7. The AC power supply apparatus according to claim 1, wherein
the control unit comprises:
a vector detection unit that calculates a measurement vector value representing an amplitude and a phase of each of the first to third AC voltages output to the first to third terminals, respectively; and
a waveform adjustment unit that calculates a difference value between the measurement vector value and a waveform set value representing the amplitude set value and the phase set value, and updates the control signal for controlling the first to third AC power supply generation units, so as to decrease the difference value.

8. The AC power supply apparatus according to claim 7, wherein
the first to third AC power supply generation units generate the first to third AC voltages, respectively, based on the control signal output from the control unit, and
the waveform adjustment unit outputs the control signal and adjusts a pulse width and a phase of the control signal according to the difference value.

9. The AC power supply apparatus according to claim 8, wherein the vector detection unit uses, as a phase component of the measurement vector value, a difference value between a preliminarily set reference phase value and the phase of each of the first to third AC voltages.

10. The AC power supply apparatus according to claim 7, wherein the vector detection unit uses, as a phase component of the measurement vector value, a difference value between a preliminarily set reference phase value and the phase of each of the first to third AC voltages.

11. The AC power supply apparatus according to claim 1, wherein
the first AC voltage and the third AC voltage have reversed phases,
a first load is connected between the first terminal and the second terminal, and
a second load is connected between the second terminal and the third terminal.
